(19) United States
(12) Patent Application Publication
(10) Pub. No.: US 2026/0298348 A1
(43) Pub. Date: Oct. 1, 2026

(54) DEVICE FOR METERING A CRYOGENIC MEDIUM

(71) Applicants: Messer SE & Co. KGaA, Bad Soden (DE); Messer France S.A.S., Suresnes Cedex (FR)

(72) Inventors: Denis Beil, Duisburg (DE); Frank Gockel, Velbert (DE); Emir Tebib, Gressy (FR)

(73) Assignees: Messer SE & Co. KGaA, Bad Soden (DE); Messer France S.A.S., Suresnes Cedex (FR)

(21) Appl. No.: 19/474,770

(22) PCT Filed: Apr. 4, 2024
(86) PCT No.: PCT/EP2024/059194

§ 371 Date: Oct. 13, 2025

(30) Foreign Application Priority Data
Apr. 14, 2023 (DE) 10 2023 109 505.6

(51) Int. Cl. F16K 1/30; F16K 1/12; F16K 1/38; F16K 31/06; F17C 13/04

(52) U.S. Cl. CPC F16K 1/302; F16K 1/12; F16K 1/38; F16K 31/0675; F17C 13/04; F17C 2205/0323; F17C 2221/013; F17C 2221/014; F17C 2221/016; F17C 2223/0161

(57) ABSTRACT

A device is provided for metering a cryogenic medium, for example liquid nitrogen, liquid oxygen or liquid carbon dioxide, into a container containing the product. The feeding in of the cryogenic medium takes place by means of a device which has a valve mounted in the wall of the container and connected to a supply line for the cryogenic medium. The valve is equipped with a shut-off member which is accommodated in a valve housing and can be brought in the axial direction against the action of a restoring spring from a closed state into an open state, in which the cryogenic medium can flow into the container at a nozzle opening. The shut-off member is at least partially made of a ferromagnetic material and, for moving into its open position, acts together with an electromagnet arranged on the outside of the valve housing.

### CROSS-REFERENCE TO RELATED APPLICATIONS

The present application is the U.S. national stage application of international application PCT/EP2024/059194 filed Apr. 4, 2024, which international application was published on Oct. 17, 2024, as International Publication WO 2024/213462A1. The international application claims priority to German Patent Application No. 10 2023 109 505.6 filed Apr. 14, 2023. The international application and German application are hereby incorporated herein by reference.

### FIELD

The invention relates to a device for metering a cryogenic medium into a container, with a valve which has a valve housing which can be fastened in the wall of the container, is equipped with a connection for connecting a supply line for the cryogenic medium and with a nozzle opening arranged in a wall section of the valve housing for introducing the cryogenic medium into the container and in which a shut-off member is accommodated axially movably in such a way that it can be brought from a closed state, in which the shut-off member closes the nozzle opening with a closing section, into an open state, in which the closing section is arranged at a distance from the nozzle opening and thus releases it, and in which the axial movement of the shut-off member from its closed state into the open state takes place against the action of a recoiling spring element.

### BACKGROUND

Cryogenic media, especially cryogenic liquids or gases, are used in many industrial applications for cooling or freezing liquid, pasty or solid products. The heat transfer in this case takes place either indirectly, i.e. without material contact between the product to be cooled and the cryogenic medium via heat exchanger surfaces, or by direct contact of the product with the cryogenic medium, in which
the product to be cooled is usually passed through a line or collected in a vessel and the cryogenic medium is introduced into the line or into the vessel via suitable nozzles, valves or other metering devices. In the following, the terms “line” and “vessel” are subsumed within the term “container”.

If the product to be cooled is in a vessel, for example in a mixer, there are various possibilities for feeding in the cryogenic medium: When it is introduced in the head space of the vessel, the entry points for the cryogenic medium have no contact or only little contact with the product to be cooled. Since there is a certain distance between the product and the entry points, the risk of icing of the entry points is low. Simple valves or nozzles can therefore be used-for example spray nozzles or capillary nozzles, which are always open with respect to the interior of the vessel. However, a disadvantage of these systems is that it is only ever a part of the cryogenic medium that comes into contact with the product and can extract heat from it, while the remaining, often larger part escapes unused into the atmosphere or is diverted away via a discharge. A further disadvantage of nozzles that are always open with respect to the interior of the vessel is that cleaning agents or water can penetrate there. In addition to the possibility of the formation of bacterial nests, there is a risk that, when a cryogenic medium is introduced, the penetrated liquid crystallizes out and clogs the metering member.

In order to be able to transfer the thermal energy to the cryogenic medium better, the cryogenic medium is alternatively introduced directly into the product. For this purpose, the entry points for the cryogenic medium are not located in the head space, but in a lower part of the vessel, i.e. in the area that is filled with the product to be cooled during treatment. However, in the case of this procedure, also referred to in technical jargon as “bottom injection”, it must be ensured that the valve can always be closed, in order to prevent the entry points from freezing during treatment due to freezing product and thus becoming blocked or impaired in their functionality. It is also necessary to prevent product from penetrating into the interior of the nozzle and permanently accumulating there, which would pose the risk of contamination. The problem addressed here also applies correspondingly to the injection of a coolant into a line through which a liquid, or generally flowable, product flows.

A valve suitable for use in the context of “bottom injection” for introducing a cryogenic medium is described in DE 101 52 764 A1. The valve comprises a valve housing that is integrated in the wall of a container, for example a mixer. Arranged in the valve housing is a valve opening with a small opening cross section which can be closed by means of a valve needle in such a way that, when the valve is closed, the front surface of the valve needle finishes substantially flush with the valve housing or the inner surface of the vessel. This arrangement is disadvantageous insofar as, in the event of a sudden drop in pressure in the coolant supply line, product from the vessel can penetrate into the interior of the valve.

WO 2008/007000 A2 describes another device for metering in a cryogenic medium. This device comprises a valve with a piston-shaped shut-off member which is accommodated axially movably in a tubular guide channel against the resistance of a spring and is equipped with a closing plate on the end face. Provided on the side of this guide channel are a number of passages for introducing a cryogenic medium, which are flow-connected to a supply line for the cryogenic medium. The mouth openings of the passages are arranged in such a way that they can be closed with the closing plate of the shut-off member under the action of the spring. If the pressure in the coolant supply line, and thus in the feedthroughs, exceeds a certain limit value determined by the spring force, the valve opens. When the pressure in the coolant supply line decreases, the piston and the closing plate automatically move into the closed state under the action of the spring.

EP 1 867 902 A2 and EP 2 309 160 A1 also disclose devices for metering a cryogenic medium into a treatment space, in which a shut-off member equipped with a closing plate is arranged in a guide channel axially movably to a limited extent against the action of a spring. The guide channel of the shut-off member also serves in this case as a flow channel for the cryogenic medium, which simplifies the structure of the valve and reduces the risk of freezing.

However, a problem with the aforementioned devices in which the valve is moved against the action of a spring due to the positive pressure of the coolant to be metered in, is that, when there are only small differences in pressure, the valve is not necessarily functional. The pressure of the cryogenic medium to be metered in must therefore always exceed a certain value, which leads to additional equipment expenditure.

### SUMMARY

The object of the present invention is therefore to provide a device for metering in a cryogenic medium which has a simple structure and is also suitable with high reliability for injecting the cryogenic cooling medium into a lower region of a container which is filled with product to be cooled or through which product to be cooled flows, and can also be used satisfactorily when there are small differences in pressure between the cryogenic medium to be metered in and the ambient pressure.

This object is achieved by a device with the features recited in the claims.

According to the invention, a device of the type and purpose mentioned above is therefore characterized in that the shut-off member at least partially consists of ferromagnetic material and, for moving into its open position, acts together with an electromagnet arranged on the outside of the valve housing.

According to the invention, therefore, the axial movement of the shut-off member into its open state against the force effect of the spring element is brought about by the actuation of an electromagnet which is arranged on the outside of the valve housing, i.e. without direct contact with the cryogenic medium. For this purpose, the shut-off member as a whole, or at least a part thereof, is made of a ferromagnetic material, such as for example ferromagnetic, cold-resistant steel. After bringing the shut-off member into its open position, the nozzle opening is released and the cryogenic medium provided by the supply can flow into the container. After the magnetic field has been switched off, the shut-off member automatically moves to its closed position under the action of the recoiling spring element. The device according to the invention reliably prevents the penetration of product into the interior of the valve even in the event of pressure fluctuations in the supply line for the cryogenic medium and reliably ensures a supply of the cryogenic medium into the container even when there are small differences in pressure between the supply line and the container.

A “container” is to be understood within the scope of the invention as meaning a vessel filled with a product to be cooled or a pipeline through which such a product flows. Vessels of this type are used, for example, in the food industry or in the pharmaceutical industry for the batch production of a product or precursor; to carry out the aforementioned “bottom injection”, the valve is in this case preferably arranged in a region of the vessel which is wetted during the use as intended of a product received in the vessel, so that the cooling medium is introduced directly into the product and thus intimately mixed with it. As a pipeline, the container may also be a pressure line through which a fluid to be treated flows.

For example, the device according to the invention is used for introducing carbon dioxide or liquid nitrogen, for example in environmental technology for treating wastewater or for refreshing or sterilizing liquid foods such as wine, juices or milk.

It is also not necessary within the scope of the invention, though not ruled out, that, when the valve is actuated, the supply of cryogenic medium to the valve housing is also at the same time blocked or opened. Preferably, even in the closed state of the valve, the valve housing is filled with cryogenic medium which is under a certain positive pressure relative to the pressure in the container. For example, the difference in pressure relative to the pressure in the container in the case of liquid nitrogen or liquid oxygen is between 0.1 bar and 6 bar, preferably between 1.5 and 4 bar; in the case of carbon dioxide, the pressure in the supply line for the cryogenic medium corresponds to at least the pressure of the triple point (5.18 bar), preferably 8 to 20 bar, to keep the carbon dioxide in the liquid state. The container itself is in this case often operated without pressure, i.e. in the interior there is ambient pressure, but can also be operated at a pressure which is only slightly lower, for example between 0.01 and 0.1 bar lower, than the pressure of the cryogenic medium in the valve housing itself.

Preferably, the shut-off member is installed in the valve housing in such a way that in the closed state of the valve the closing section of the shut-off member is pressed by a pressure of the cryogenic medium acting in the interior of the valve housing against the wall section of the valve housing having the nozzle opening and to open the valve is moved against this pressure into the interior of the valve housing. In order to overcome the pressure of the cryogenic medium prevailing in the interior of the valve housing, which keeps the valve in its closed state in addition to the force of the spring means, the electromagnet is therefore preferably designed to withstand overvoltage, i.e. it can be briefly operated undamaged with a short strong current pulse, which exerts the magnetic force effect required to open the shut-off member against the positive pressure of the cryogenic medium. Once the valve has been opened, a lower electrical current is sufficient to generate a magnetic force effect that compensates for the spring force and to keep the valve in the open position. The strength of these two electrical currents depends on the respective situation, in particular on the pressure of the cryogenic medium supplied and on the restoring force of the spring means.

The nozzle opening preferably forms the direct flow connection between the interior of the valve housing and the interior of the container; the wall section of the valve housing having the nozzle opening therefore at the same time forms a wall section of the container. In this case, there are no lengthy stretches of line in which product from the container can accumulate during the closing phase of the valve. The nozzle opening preferably has an opening cross section which is dimensioned such that, during the normal operating process, in the open state a predetermined minimum positive pressure always remains in the valve housing relative to the container, which in turn prevents the penetration of product into the valve housing.

In a particularly compact design of the device, the electromagnet is formed as a tubular lifting magnet, in the tubular interior space of which at least a part of the valve housing is accommodated.

The spring element is made of a cold-resistant material, which retains a certain elasticity even at the cryogenic temperatures prevailing in the valve body, in order to be able to maintain the restoring force effect in the use of the valve, for instance stainless steel. A particularly advantageous configuration of the invention provides that the spring element has a spiral spring which extends in the valve housing, between a spring seat which is arranged in a side of the valve housing facing away from the wall section with the nozzle opening, and a rear section of the shut-off member, i.e. a section facing away from the closing section. Preferably, the spring element is detachably accommodated in the valve housing in order to be easily replaceable in the event of damage or in the event of a different restoring force being required.

In an advantageous configuration of the invention, the nozzle opening is a cylindrical bore which, for closing the valve, acts together with a likewise cylindrically shaped closing section of the shut-off member, which for this purpose is inserted into the nozzle opening. This effectively prevents the nozzle opening from freezing.

A likewise advantageous configuration of the invention provides that the wall section of the valve housing having the nozzle opening is shaped on its inner side facing the interior of the valve housing as conical, narrowing toward the nozzle opening, and for closing the valve acts together with a corresponding conical shaping of the closing section of the shut-off member. In the case of this configuration, the flow cross section of a ring channel existing between the two conical boundaries can be varied by changing the distance of the shut-off member from the nozzle opening, and thus the flow of the cryogenic medium supplied to the container can be set. In addition, other configurations of the closing section of the shut-off member or of the shut-off member as a whole are conceivable, such as for example a spherical shut-off member, which is itself moved by the electromagnet.

Preferably, the valve housing is detachably connected to the wall of the container. This can take place, for example, by screwing into a thread arranged in an opening of the wall of the container. In particular in the food sector, a particularly preferred configuration of the invention provides that the valve housing is connected to the container via a connection piece, which for its part is firmly connected, for example by welding, to the wall of the container. The valve housing is inserted with its front section having the nozzle opening into the connection piece and is detachably connected to the connection piece at the end thereof facing away from the container, for example by means of a clamping flange connection or in the manner of an ingold socket by means of a union nut. Preferably, a suitable sealing element, such as a sealing ring, arranged between the inner surface of the connection piece and the inserted front section ensures that as far as possible no product from the interior of the container can penetrate into the annular gap between the connection piece and the front section. In the case of this configuration, there is a particularly low risk that product residues from the container permanently accumulate in gaps and openings of the valve fastening.

A further advantageous configuration of the invention provides that the valve is equipped with means for controlling the flow rate of cryogenic medium supplied to the container. Thus, the supply of cryogenic medium can be regulated by means of a control unit in accordance with a predetermined program and/or measured parameters, such as a temperature in the container.

In order to reliably prevent the penetration of product from the container into the valve housing in the closed state of the valve, a sealing element which is arranged in the wall section of the valve housing having the nozzle opening and/or in the closing section of the shut-off member is expediently provided. The sealing element is made of a low-temperature resistant material such as Teflon. This is, for example, a sealing ring accommodated in a peripheral groove of the wall section or the closing section, or the closing section of the shut-off member may itself be made of Teflon and in the closed state is pressed as a whole against the wall section having the nozzle opening.

The device according to the invention is preferably intended and suitable for the use of a liquefied gas, such as liquid nitrogen, liquid oxygen or liquid carbon dioxide, or else a cold gas, such as cryogenic gaseous nitrogen, nitrous oxide (NO2) or argon. In general, the device according to the invention can be used to meter gas or a liquid into a gas, a liquid or into a pasty, powdery or lumpy substance. Cryogenic liquefied nitrogen is an efficient and usually inert cooling medium. Nitrous oxide is widely used as a sterilizing gas in food applications. The use of cold oxygen in the cooling of meat or meat mass in particular not only leads to a good cooling effect, but also at the same time contributes to maintaining the red meat color. A likewise advantageous cryogenic medium is carbon dioxide, which is provided in a liquid form via the supply line and expands upon entry into the container, producing carbon dioxide snow and carbon dioxide gas.

### BRIEF DESCRIPTION OF THE DRAWINGS

An exemplary embodiment of the invention is to be described in more detail on the basis of the drawing. In schematic views:

FIG. 1 shows a device according to the invention for metering a cryogenic medium into a vessel in a first embodiment in a longitudinal section.

FIG. 2 shows a device according to the invention for metering a cryogenic medium into a vessel in a second embodiment in a longitudinal section shown in the form of a detail.

### DETAILED DESCRIPTION

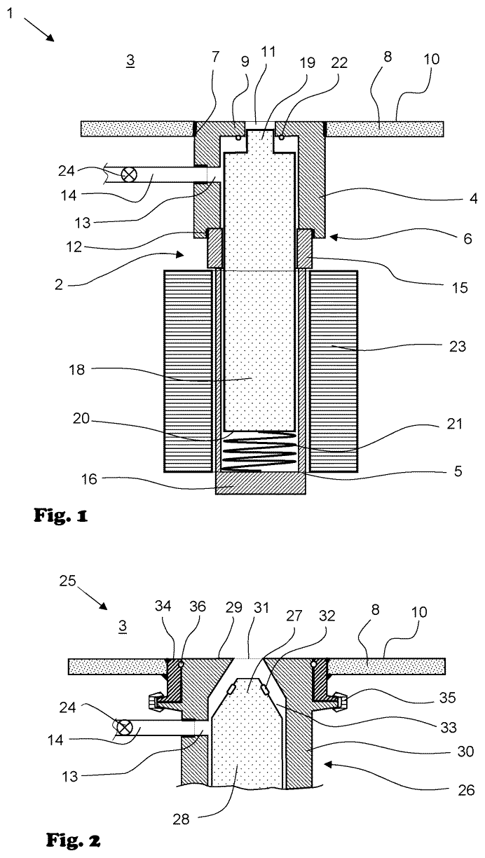

The device 1 shown in FIG. 1 comprises a valve 2, which is mounted on a container 3, for instance a vessel intended for receiving a product to be cooled or a fluid-carrying pipeline. The valve 2 has a valve housing 6 made up of two housing parts, a front section 4 and a rear section 5.

In the exemplary embodiment according to FIG. 1, the valve 2 is connected to the container 3 by screwing, specifically by screwing in the front section 4 in an opening provided with a thread 7 in a wall 8 of the container 3. In this case, the front section 4 should in its installed state be accommodated in the wall 8 in such a way that, as shown here, it finishes flush with an inner surface 10 of the wall 8. An alternative fastening possibility by means of a connection piece with a clamping connection is shown in FIG. 2 and explained in more detail below.

The front section 4 of the valve housing 6 is formed as substantially tubular-cylindrical and, on its wall section facing the interior of the container 3 in the installed state—referred to here as the front surface 9—is closed with the exception of a nozzle opening 11. Furthermore, the front section 4 is equipped with a thread 12 for detachably fastening the rear section 5.

At a distance from the front surface 9, a connection hole 13—in the exemplary embodiment shown here equipped with a thread—for connecting a supply line 14 for a cryogenic medium is arranged in a side wall of the front section 4. Instead of a thread, other fastening means may also be provided for connecting the supply line 14 to the front section 4, for example a flange connection; the type of connection is in this case adapted to the cryogenic medium used and from case to case is designed to be resistant to pressure and/or low temperature.

For example, a liquefied gas such as liquid nitrogen, liquid oxygen or liquid carbon dioxide, or else a cold gas, for example cryogenic gaseous nitrogen, nitrous oxide or argon, is used as the cryogenic medium. In general, the device according to the invention can be used to meter gas or a liquid into a gas, a liquid or into a pasty, powdery or lumpy substance.

The likewise tubular rear section 5 of the valve housing 6 is mounted with a fastening section 15 on the front section 4 in a gas-tight and pressure-resistant manner, in the example shown here screwed in in the thread 12, and is formed on its end face opposite from the fastening section 15 as closed, while a spring seat 16 is formed. The rear section 5 preferably consists of a non-magnetic or paramagnetic material, for example of a non-magnetic stainless steel.

In the interior of the valve housing 6, a shut-off member 18 by means of which the valve 2 can be closed and opened is accommodated axially movably. In the exemplary embodiment shown here, the shut-off member 18 consists of a substantially cylindrically formed closing body made of a ferromagnetic material, arranged on the side of which facing the front surface 9 is a cylindrical closing section 19, which is adapted to the inner cross section of the likewise cylindrical nozzle opening 11 in such a way that in the closed state of the valve 2 it is accommodated in this opening in a sealing or almost sealing manner.

A spring means 21, here a spiral spring, is arranged between an end face 20 of the shut-off member 18 opposite from the closing section 19 and the spring seat 16 of the rear section 5. The spring means 21 is under preload and in the closed state of the valve 2 presses the shut-off member 18 against the front surface 9 of the front section 4. In order to further improve the tightness, a sealing means made of a flexible and cold-resistant material, such as Teflon, is provided, for example a sealing ring 22, which is accommodated in a groove running peripherally around in the front surface 9.

Radially on the outside of the rear section 5 there is a tubular electromagnet 23, which encloses the entire rear section 5, at least below the fastening section 15. The electromagnet 23 serves to actuate the valve 2 in the manner described below.

Without actuation of the electromagnet 23, i.e. without an active magnetic field, the valve 2 is in its closed state, i.e. the shut-off member 18 is pressed against the front surface 9 due to the force of the spring means 21. In this state, the closing section 19 extends through the nozzle opening 11 and toward the inside of the container 3 finishes flush with the inner wall 10. By opening a valve 25 in the supply line 14, cryogenic medium flows via the supply line 14 into the interior of the valve housing 6 and, due to its positive pressure relative to the pressure in the container 3, contributes to the pressing of the shut-off member 18 against the front surface 9.

To open valve 2, the electromagnet 23 is actuated. This generates in the interior of the valve housing 6 a magnetic field which exerts on the ferromagnetic shut-off member 18 a force which is opposed to the force of the spring means 21. If the magnetic force of the electromagnet 23 exceeds the combined force of the spring means 21 and the force on the shut-off member 18 generated by the positive pressure of the cryogenic medium, the shut-off member is displaced in the direction of the spring seat 16, and thus releases the nozzle opening 11 (open state of the valve 2). In this open state, the cryogenic medium provided via the supply line 14 can flow into the interior of the container 3. Since in the open state of the valve 2 there is no longer any positive pressure which presses the shut-off member 18 against the front surface 9, a lower magnetic force field is sufficient to maintain the open state. Accordingly, the electromagnet 23 is preferably operated in such a way that a short, strong current pulse is given at the beginning, which moves the shut-off member 18 into its open position. Subsequently, a lower continuous current is sufficient to generate a magnetic field sufficient to keep the shut-off member 18 in its open position. After the electromagnet 23 has been switched off, the shut-off member 18 automatically returns into its closed position due to the action of the spring means 21.

Due to the constant positive pressure of the cryogenic medium in the supply line 14 or in the interior of the valve housing 6 relative to the internal pressure in the container 3, it is ensured that no material from the container 3 can penetrate into the supply line 14. By means of an automatic control not shown here, it can be ensured that the electromagnet 23 is automatically switched off, and the valve is thus closed, as soon as the pressure in the supply line 14 is below a certain value, so that even in this case no material from the container 3 can penetrate into the supply line 14.

The valve housing 6, the shut-off member 19 and the spring means 22 are made of a material that allows for the low temperatures and/or the high pressures of the cryogenic medium respectively used, for example of a suitable, low-temperature resistant stainless steel. Furthermore, the parts 4, 5, 18, 21, 22 are preferably detachably mounted in the valve 2, whereby not only is any maintenance facilitated, but also the valve 2 can be adapted to the respectively used cryogenic medium and/or the treatment task.

The device 25 shown in FIG. 2 differs from the device 1 in FIG. 1 only by the different design in the region of the nozzle opening, and is therefore only shown in a detail. Components that otherwise have the same effect are provided with the same reference numerals as in the case of the device 1.

The device 25 has a valve 26 with a shut-off member 28, in which a closing section 27 of the shut-off member 28 is conically shaped and, for closing a nozzle opening 31 of the valve 26, acts together with a likewise conically shaped inner surface of a front surface 29 of the valve housing 30. As a difference from the device 1, here a seal is not provided in the form of a sealing ring arranged in a groove of the front surface 9, but in the form of a sealing ring 32 drawn over the closing section 27. Otherwise, however, other suitable possibilities for sealing may also be used.

The conical shaping of the front surface 29 and closing section 27 has the effect that the width of the annular gap 33 between the front surface 29 and the closing section 27 can be changed by changing the axial position of the shut-off member 28. In this way it is possible to vary the flow of cryogenic medium emerging from the nozzle opening 32 in accordance with the position of the shut-off member 28, i.e. the current applied to the electromagnet 23. By means of a suitable control device (not shown here), in this case the inflow of cryogenic medium can be varied in accordance with a measured parameter, for example the temperature in the container 3.

In order to improve the hygienic conditions, the valve 26 is accommodated with a front section of the valve housing 30 in a connection piece 34, which is welded in the wall 8 of the container 3, and is detachably connected to the connection piece 34 by means of a flange connection with a clamping ring 35. Here, too, the front surface on the vessel side is flush with the inner surface 10 of the wall 8. Between the outer wall of the front section of the valve housing 30 and the inner surface of the connection piece 34, a sealing element, for example a sealing ring 36 made of Teflon, is arranged in corresponding grooves of the valve housing 30 or the connection piece 34, in order to prevent product from the interior of the container 3 from penetrating into the annular gap between the valve housing 30 and the
connection piece 34. Instead of the connection piece 34 with a clamping ring 35 shown here, an ingold socket (not shown here), which is equipped in a known manner with a union nut for fastening the valve 26, may otherwise also be used.

The devices 1, 25 satisfy in particular the high hygienic requirements for the treatment of foods such as dough, flour, mash or meat mass for the production of sausages, or for the production of pharmaceutical products, precursors or ingredients. Another area of application relates to the metering of a cryogenic medium into a line through which a gas or a liquid flows, for example in the treatment of waste water or the treatment of wine, juices or milk.

### LIST OF REFERENCE NUMERALS

1. Device
2. Valve
3. Container
4. Front section
5. Rear section
6. Valve housing
7. Thread
8. Wall
9. Front surface
10. Inner surface
11. Nozzle opening
12. Thread
13. Connection hole
14. Supply line
15. Fastening section
16. Spring seat
17. 13
18. Shut-off member
19. Closing section
20. End face
21. Spring means
22. Sealing ring
23. Electromagnet
24. Valve
25. Device
26. Valve
27. Closing section
28. Shut-off member
29. Front surface
30. Valve housing
31. Nozzle opening
32. Sealing ring
33. Annular gap
34. Connection piece
35. Clamping ring
36. Sealing ring

1. A device for metering a cryogenic medium into a container, the device having:
a valve comprising:
a valve housing which can be fastened in the wall of the container, which is equipped with a connection for connecting a supply line for the cryogenic medium, and which is equipped with a nozzle opening arranged in a wall section of the valve housing for introducing the cryogenic medium into the container;
a shut-off member that is accommodated axially movably in the valve housing in such a way that the shut-off member can be brought from a closed position, in which the shut-off member closes the nozzle opening with a closing section, into an open position, in which the closing section is arranged at a distance from the nozzle opening and thus releases the nozzle opening, and in which the axial movement of the shut-off member from the closed position into the open position takes place against the action of a recoiling spring element;
wherein the shut-off member at least partially comprises ferromagnetic material and, for moving into the open position, acts together with an electromagnet arranged on the outside of the valve housing.

2. The device as claimed in claim 1, wherein the shut-off member is installed in the valve housing in such a way that in the closed position of the shut-off member, the closing section of the shut-off member is pressed by a pressure of the cryogenic medium acting in the interior of the valve housing from inside against the wall section of the valve housing having the nozzle opening.

3. The device as claimed in claim 1, wherein the electromagnet is formed as tubular and encloses at least some sections of the valve housing.

4. The device as claimed in claim 1, wherein the spring element has a spiral spring which extends in the valve housing, between an end face of the shut-off member facing away from the container and a spring seat of the valve housing.

5. The device as claimed in claim 1, wherein the nozzle opening is formed as a cylindrical bore which extends through the wall section of the valve housing and, for closing the valve, acts together with a corresponding cylindrical shaping of the closing section of the shut-off member.

6. The device as claimed in claim 1, wherein the wall section of the valve housing having the nozzle opening is shaped on its inner side as conical, narrowing toward the nozzle opening, and for closing the valve acts together with a corresponding conical shaping of the closing section of the shut-off member.

7. The device as claimed in claim 1, wherein the valve housing is detachably connected to the wall or to a connection piece mounted firmly on the wall of the container.

8. The device as claimed in claim 1, wherein the valve is equipped with means for controlling the flow rate of cryogenic medium supplied to the container.

9. The device as claimed in claim 1, wherein a peripheral sealing element is provided in the wall section of the valve housing and/or in the closing section of the shut-off member.

10. The device as claimed in claim 1, wherein liquid or gaseous nitrogen, liquid or gaseous carbon dioxide, liquid or gaseous argon or liquid or gaseous nitrous oxide is used as the cryogenic medium.

11. The device as claimed in claim 9, wherein the peripheral sealing element is a sealing ring accommodated in a peripheral groove in the wall section of the valve housing and/or in the closing section of the shut-off member.
